(19) United States
(12) Patent Application Publication
(10) Pub. No.: US 2026/0108896 A1
(43) Pub. Date: Apr. 23, 2026

(54) ATOMIZER FOR AERIAL SPRAYING AND CONTROL METHOD THEREOF

(71) Applicant: Research Center of Intelligent Equipment, Beijing Academy of Agriculture and Forestry Sciences, Beijing (CN)

(72) Inventors: Ruirui ZHANG, Beijing (CN); Liping CHEN, Beijing (CN); Chenchen DING, Beijing (CN); Longlong LI, Beijing (CN); Gang XU, Beijing (CN)

(21) Appl. No.: 18/566,786

(22) PCT Filed: Sep. 5, 2023
(86) PCT No.: PCT/CN2023/116860

§ 371 Date: Dec. 4, 2023

(30) Foreign Application Priority Data
Jul. 13, 2023 (CN) 202310857398.X

(51) Int. Cl. B05B 3/02; B05B 12/12

(52) U.S. Cl. CPC B05B 3/0204; B05B 12/12

(57) ABSTRACT

An atomizer for aerial spraying and a control method thereof are provided and relate to the technical field of agricultural machinery. The atomizer for aerial spraying includes a rotary cage atomizer, a deflection mechanical arm, a transmission assembly, and a driving assembly. The rotary cage atomizer is connected to the deflection mechanical arm via a first adapter, the deflection mechanical arm is connected to the transmission assembly, the driving assembly drives the transmission assembly, so as to drive the deflection mechanical arm to adjust an angle, the angle of the rotary cage atomizer changes along with the change of the angle of the deflection mechanical arm, and a brushless motor is used to adjust the rotation speed of the rotary cage atomizer. The rotary cage atomizer is provided with a primary atomizing valve core and a secondary atomizing rotary cage.

### CROSS-REFERENCE TO RELATED APPLICATION

This application is a national stage application of International Patent Application No. PCT/CN2023/116860, filed on Sep. 5, 2023, which claims priority to Chinese Patent Application No. 202310857398.X, filed on Jul. 13, 2023, the content of each of which are hereby incorporated by reference.

### BACKGROUND

### Technical Field

The present disclosure relates to the technical field of agricultural machinery, and provides an atomizer for aerial spraying and a control method thereof.

### Background

In the process of pest control, traditional pesticide application machinery has some problems, such as low working efficiency, serious environmental pollution, and easy poisoning of operators. However, aerial spraying by an agricultural aircraft has the advantages, such as fast flight speed, strong environmental adaptability, high spraying efficiency, strong ability to deal with sudden disasters and no limitation of crop growth, which makes up for the shortcomings of traditional pesticide application machinery and manual operation, and thus has been highly valued in the field of agricultural plant protection.

During aerial spraying, pesticide droplets may drift under the influence of ambient airflows, temperature and humidity, which affects non-target areas and thus causes secondary disasters. In order to improve the pesticide utilization efficiency, improve the operation effect and reduce pesticide drift, aerial spraying in a specific operating environment has its optimal particle size for spraying.

Atomizer is a key component of an aerial spraying system. Existing atomizers for aerial spraying mainly include a hydraulic atomizing nozzle, an electrostatic nozzle and a centrifugal atomizing nozzle. A hydraulic atomizing spray head, using the pressure difference between the inside and outside of the nozzle, sprays liquid into the air to form a liquid film, and the liquid film collides with the air to form droplets; and the hydraulic atomizing spray head has poor control over the droplet size, poor environmental adaptability and easy blockage. The liquid pesticide in the electrostatic nozzle is charged in a spray head to form a group of charged droplets, and the droplets sprayed into the air make directional movement under the combined action of an electric field force and other external forces, so as to achieve the operating objectives of high deposition rate, low drift and environmental protection. The atomization mechanism of the electrostatic nozzle is complex, which is not conducive to the achievement of controllable droplet size variables. The centrifugal atomizing nozzle can atomize the liquid pesticide by means of a centrifugal turntable or a centrifugal rotary cage, and the atomized droplet is more controllable in size and is better in consistence, and thus is more suitable for aerial spraying.

However, the existing centrifugal atomizing nozzle has the defects of droplet drift and large energy consumption and the like, which is difficult to meet the requirements of accurate aerial spraying in agriculture.

### SUMMARY

An atomizer for aerial spraying and a control method thereof are provided to solve the problem that the atomizer for aerial spraying in the prior art is easy to cause droplet drift.

In a first aspect, an atomizer for aerial spraying includes a rotary cage atomizer, a deflection mechanical arm, a transmission assembly, and a driving assembly.

The rotary cage atomizer includes a primary atomizing valve core, a secondary atomizing rotary cage, a brushless motor, a first adapter, and a paddle. The primary atomizing valve core is arranged in the secondary atomizing rotary cage. The paddle includes a blade mounting base and multiple blades. The blade mounting base includes a liquid pipeline, a side wall arranged on a periphery of the liquid pipeline, and a bottom wall for connecting the liquid pipeline and the side wall. The side wall is movably covered with the first adapter, and the first adapter is opposite to the bottom wall. The first adapter is provided with a liquid inlet in communication with the liquid pipeline, the brushless motor sleeves the liquid pipeline, and the multiple blades are arranged on a periphery of the side wall in a circumferential direction of the side wall. The secondary atomizing rotary cage is connected to the bottom wall, the first adapter is connected to the deflection mechanical arm, and the deflection mechanical arm is connected to the driving assembly via the transmission assembly.

According to the atomizer for aerial spraying provided by the present disclosure, the secondary atomizing rotary cage includes a rotary cage body, and a first connecting portion. An opening of the rotary cage body is covered with the first connecting portion, and the first connecting portion is provided with a first via hole.

The primary atomizing valve core includes a valve core body, and a second connecting portion. An opening of the valve core body is provided with the second connecting portion covers, and the second connecting portion is provided with a second via hole. The first connecting portion is provided with a first side and a second side opposite to each other, the second connecting portion is arranged on the first side, the bottom wall is arranged on the second side, and the first via hole, the second via hole, the liquid pipeline and the liquid inlet are in communication with one another in sequence.

According to the atomizer for aerial spraying provided by the present disclosure, the projection area of the bottom wall on the first connecting portion is less than the area of the first connecting portion.

According to the atomizer for aerial spraying provided by the present disclosure, the deflection mechanical arm includes multiple pairs of spherical gear assemblies arranged in sequence.

According to the atomizer for aerial spraying provided by the present disclosure, in a case that the deflection mechanical arm includes three pairs of spherical gear assemblies, the deflection mechanical arm further includes a primary holder, a secondary holder, a tertiary holder, and a bottom hood.

The primary holder is connected to the bottom hood, the bottom hood is connected to a convex spherical gear in a first pair of spherical gear assembly, and the primary holder is connected to a concave spherical gear in a second pair of spherical gear assembly. The secondary holder is connected to a concave spherical gear in the first pair of spherical gear assembly and a concave spherical gear in a third pair of spherical gear assembly. The tertiary holder is connected to a convex spherical gear in the third pair of spherical gear assembly and the concave spherical gear in the second pair of spherical gear assembly.

According to the atomizer for aerial spraying provided by the present disclosure, the first adapter includes a cover body, a first vertical portion extending to a circumferential side of the cover body, an inclined portion bent from the first vertical portion, and a second vertical portion extending from the inclined portion. The side wall is movably covered with the cover body, the cover body is provided with the liquid inlet, and the second vertical portion is connected to the convex spherical gear in the third pair of spherical gear assembly.

According to the atomizer for aerial spraying provided by the present disclosure, the deflection mechanical arm further includes a second adapter. The second adapter includes a first sleeve, and a first bottom plate arranged on one side of the first sleeve, the first sleeve sleeves the convex spherical gear in the third pair of spherical gear assembly, and the second vertical portion is connected to the first bottom plate.

According to the atomizer for aerial spraying provided by the present disclosure, the driving assembly includes a driving motor and a driving motor mounting base, and the transmission assembly includes a worm wheel, a first worm, a second worm, and a third adapter.

The driving motor is arranged on the driving motor mounting base, the worm wheel is arranged on an output shaft of the driving motor, and the first worm and the second worm are meshed with the worm wheel. The first worm penetrates through the driving motor mounting base and is movably connected to a periphery of the bottom hood. The second worm penetrates through the driving motor mounting base and is movably connected to the periphery of the bottom hood. The first worm and the second worm are arranged in parallel. One end of the third adapter is movably connected to the convex spherical gear in the first pair of spherical gear assembly, and the other end of the third adapter is movably connected to the driving motor mounting base.

According to the atomizer for aerial spraying provided by the present disclosure, the driving assembly further includes a second sleeve, and a second bottom plate. The second sleeve is arranged on a periphery of the driving motor mounting base via the second bottom plate, each of the first worm and the second worm penetrates through the driving motor mounting base and the second bottom plate in sequence, and the other end of the third adapter is movably connected to the second sleeve.

In a second aspect, a control method of an atomizer for aerial spraying includes: acquiring an ambient wind speed and a wind direction;
in a case that the ambient wind speed is greater than a preset wind speed, adjusting an orientation of a rotary cage atomizer by a deflection mechanical arm, making each blade perpendicular to the wind direction; and
in a case that the ambient wind speed is less than the preset wind speed, adjusting the orientation of the rotary cage atomizer by the deflection mechanical arm, enabling each blade parallel to the wind direction, and increasing a rotation speed of a brushless motor,

According to the atomizer for aerial spraying and the control method thereof provided by the present disclosure, the rotary cage atomizer is connected to the deflection mechanical arm via the first adapter, and the deflection mechanical arm is connected to the transmission assembly. The driving assembly drives the transmission assembly to drive the deflection mechanical arm to adjust an angle, the angle of the rotary cage atomizer changes along with the change of the angle of the deflection mechanical arm, and a brushless motor is used to adjust the rotation speed of the rotary cage atomizer. During aerial spraying, the angle and rotation speed of the rotary cage atomizer can be adjusted according to the current application environment. The rotary cage atomizer is provided with the primary atomizing valve core and the secondary atomizing rotary cage. The particle size of droplets is more uniform by adopting a double atomization mode. By adjusting the angle and rotation speed of the rotary cage atomizer, a wind field generated by paddles is offset from an ambient wind field, so as to reduce a situation of droplet drift, and improve the efficiency of aerial spraying.

### BRIEF DESCRIPTION OF THE DRAWINGS

To describe the technical solutions of the present disclosure or in the prior art more clearly, the following briefly introduces the accompanying drawings required for describing the embodiments or the prior art. Apparently, the accompanying drawings in the following description show merely some embodiments of the present disclosure, and those of ordinary skill in the art may still derive other drawings from these accompanying drawings without creative efforts,

FIG. 1 is a structural schematic diagram of an atomizer for aerial spraying according to the present disclosure;

FIG. 2 is a sectional diagram of a rotary cage atomizer according to the present disclosure;

FIG. 3 is an exploded diagram of a rotary cage atomizer according to the present disclosure;

FIG. 4 is a sectional diagram of a deflection mechanical arm according to the present disclosure;

FIG. 5 is a partial structural schematic diagram of a deflection mechanical arm according to the present disclosure;

FIG. 6 is a structural schematic diagram of a convex spherical gear according to the present disclosure;

FIG. 7 is a structural schematic diagram of a concave spherical gear according to the present disclosure;

FIG. 8 is a structural schematic diagram of a tertiary holder according to the present disclosure;

FIG. 9 is a partial structural schematic diagram of a transmission assembly according to the present disclosure;

FIG. 10 is a structural schematic diagram of a first worm according to the present disclosure;

FIG. 11 is a structural schematic diagram of a third adapter according to the present disclosure;

FIG. 12 is a structural schematic diagram of a driving motor mounting base according to the present disclosure;

FIG. 13 is a flow chart of a control method of an atomizer for aerial spraying according to the present disclosure.

In the drawings:
100—rotary cage atomizer; 110—primary atomizing valve core; 111—valve core body; 112—second connecting portion; 1121—second via hole, 120—secondary atomizing rotary cage; 121—rotary cage body; 122—first connecting portion; 1221—first via hole; 130—brusheless motor; 140—first adapter; 141—liquid inlet; 1421'cover body; 143—first vertical portion; 144—inclined portion; 145—second vertical portion; 150—paddle; 151—blade mounting base; 1511—liquid pipeline; 152—blade; 160—storage battery;
200—deflection mechanical arm; 210—spherical gear assembly; 211—convex spherical gear; 2111—first convex spherical gear; 2112—second convex spherical gear; 212—concave spherical gear; 2121—first concave spherical gear; 2122—second concave spherical gear; 2123—third concave spherical gear; 2124—fourth concave spherical gear; 220—primary holder; 230—secondary holder; 240—tertiary holder; 250—bottom hood; 251—first movable connector; 252—second movable connector; 260—second adapter; 261—first sleeve; 262—first bottom plate;
300—transmission assembly; 310—worm wheel; 320—first worm; 330—second worm; 340—third adapter;
400—driving assembly; 410—driving motor; 420—driving motor mounting base; 430—second sleeve; 440—second bottom plate;
500—sensing assembly; 510—rotation speed sensor; 520—flow sensor; 530—wind speed and wind direction sensor.

### DETAILED DESCRIPTION OF THE EMBODIMENTS

To make the objectives, technical solutions and advantages of the present disclosure more clearly, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

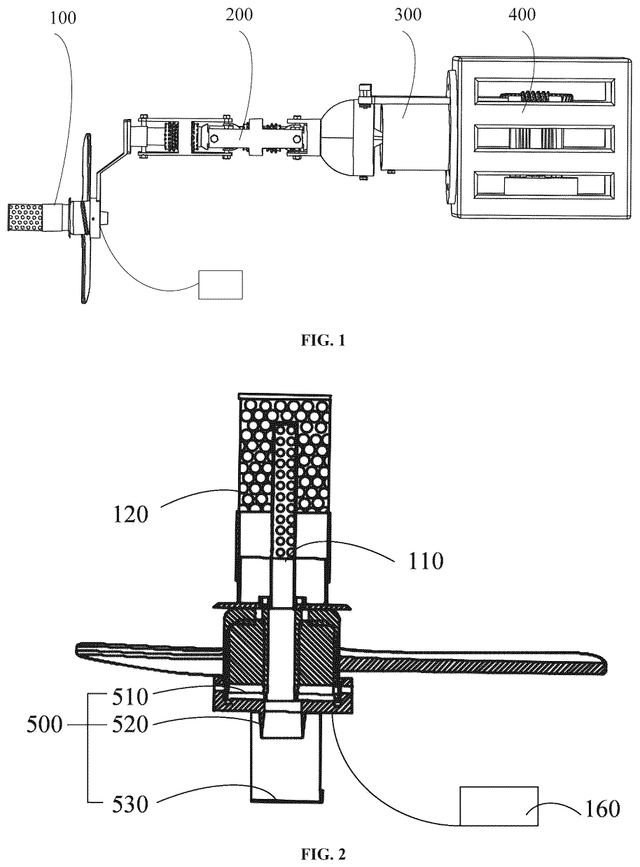

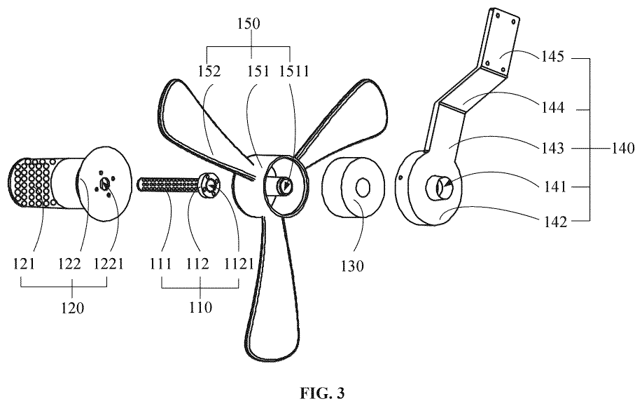

As shown in FIG. 1, FIG. 2 and FIG. 3, an atomizer for aerial spraying includes a rotary cage atomizer 100, a deflection mechanical arm 200, a transmission assembly 300, and a driving assembly 400.

The rotary cage atomizer 100 includes a primary atomizing valve core 110, a secondary atomizing rotary cage 120, a brushless motor 130, a first adapter 140, and a paddle 150. The primary atomizing valve core 110 is arranged in the secondary atomizing rotary cage 120. The paddle 150 includes a blade mounting base 151 and multiple blades 152. The blade mounting base 151 includes a liquid pipeline 1511, a side wall arranged on a periphery of the liquid pipeline 1511, and a bottom wall for connecting the liquid pipeline 1511 and the side wall. The side wall is movably covered with the first adapter 140, and the first adapter 140 is opposite to the bottom wall. The first adapter 150 is provided with a liquid inlet 141 in communication with the liquid pipeline 1511, the brushless motor 130 sleeves the liquid pipeline 1511, and the multiple blades 152 are arranged on a periphery of the side wall in a circumferential direction of the side wall. The secondary atomizing rotary cage 120 is connected to the bottom wall, the first adapter 140 is connected to the deflection mechanical arm 200, and the deflection mechanical arm 200 is connected to the driving assembly 400 via the transmission assembly 300.

Liquid pesticide enters the liquid pipeline 1511 through the liquid inlet 141, then enters the primary atomizing valve core 110 through the liquid pipeline 1511, and finally enters the secondary atomizing rotary cage 120 for secondary atomization after being atomized by the primary atomizing valve core 110.

It should be noted that the atomizer for aerial spraying can be applied to aircrafts, such as an unmanned aerial vehicle. At this time, the driving assembly 400 is located at a belly of the unmanned aerial vehicle, and a pesticide outlet of a pesticide box of the unmanned aerial vehicle communicates with the liquid inlet 141.

The side wall of the paddle 150 is covered with the first adapter 140, and the first adapter 140 is rotatably connected to the side wall of the paddle 150. In other words, the side wall of the paddle 150 can rotate with respect to the first adapter 140. In addition, the brushless motor 130 includes a fixed portion and a rotating portion. The rotating portion sleeves the fixed portion, the fixed portion is connected to an inner surface of the first adapter 140, and the rotating portion is connected to an inner surface of the side wall of the paddle 150.

In order to adjust an orientation of the rotary cage atomizer 100, the first adapter 140 is also connected to the deflection mechanical arm 200. Under the driving of the driving assembly 400, an angle of the deflection mechanical arm 200 changes, and accordingly the orientation of the rotary cage atomizer 100 also changes.

In addition, the atomizer for aerial spraying is further provided with a storage battery 160. When the atomizer for aerial spraying is affected by the ambient wind speed, the storage battery 160 may power the brushless motor 130, and the brushless motor 130 drives the rotary cage atomizer 100 to rotate, thus adjusting the rotation speed of the rotary cage atomizer 100.

In an initial stage, an axis direction of each of the primary atomizing valve core 110 and the secondary atomizing rotary cage 120 is perpendicular to the blade 152, and the deflection mechanical arm 200 is in a linear posture. In other words, the deflection mechanical arm 200 is also perpendicular to the blade 152, and a flight line direction is perpendicular to the blade 152. In a deflection state, the deflection mechanical arm 200 may be in a right-angle posture, and the flight line direction is parallel to the blade 152 at this time.

In the embodiments of the present disclosure, the rotary cage atomizer 100 is connected to the deflection mechanical arm 200 via the first adapter 140, the deflection mechanical arm 200 is connected to the transmission assembly 300, the driving assembly 400 drives the deflection mechanical arm 200 via the transmission assembly 300 to adjust an angle, a deflection angle of the rotary cage atomizer 100 changes along with the change of the deflection angle of the deflection mechanical arm 200, and the brushless motor 300 can adjust the rotation speed of the rotary cage atomizer 100. During aerial spraying, an angle and rotation speed of the rotary cage atomizer 100 can be adjusted according to the current pesticide application environment. The rotary cage atomizer 100 is provided with the primary atomizing valve core 110 and the secondary atomizing rotary cage 120. The particle size of droplets is more uniform by adopting a double atomization mode. By adjusting the angle and rotation speed of the rotary cage atomizer 100, a wind field generated by the paddle 150 is offset from an ambient wind field, so as to reduce a situation of droplet drift, and improve the efficiency of aerial spraying.

In an alternative embodiment, as shown in FIG. 2 and FIG. 3, the secondary atomizing rotary cage 120 includes a rotary cage body 121 and a first connecting portion 122. An opening of the rotary cage body 121 is covered with the first connecting portion 122, and the first connecting portion 122 is provided with a first via hole 1221.

The primary atomizing valve core 110 includes a valve core body 111, and a second connecting portion 112. An opening of the valve core body 111 is covered with the second connecting portion 112, and the second connecting portion 112 is provided with a second via hole 1121. The valve core body 111 is arranged in the rotary cage body 121. The first connecting portion 122 is provided with a first side and a second side opposite to each other, the second connecting portion 112 is arranged on the first side, the bottom wall is arranged on the second side, and the first via hole 1221, the second via hole 1121, the liquid pipeline 1511 and the liquid inlet 141 are in communication with one another in sequence.

Specifically, the periphery of the rotary cage body 121 is provided with multiple holes with uniform size. In order to obtain a proper droplet particle size, the secondary atomizing rotary cage 120 with different apertures can be replaced according to the aerial spraying condition. The first via hole 1221 is arranged at the center of the first connecting portion 122. A periphery of the valve core body 111 of the primary atomizing valve core 110 is also provided with multiple holes with uniform size, and the second via hole 1121 is arranged at the center of the second connecting portion 112.

The first via hole 1221, the second via hole 1121, the liquid pipeline 1511 and the liquid inlet 141 are coaxially provided in sequence, the apertures of which can be kept consistent, so as to form a relatively sealed environment to prevent a situation of liquid leakage when the liquid pesticide flows into the rotary cage body 121 from the liquid inlet 141.

In an embodiment of the present disclosure, liquid pesticide enters the liquid pipeline 1511 from the liquid inlet 141, and then enters the valve core body 111 for first-step atomization of the liquid pesticide after flowing through the first via hole 1221 and the second via hole 1121 in sequence. The liquid pesticide after the first-step atomization enters the rotary cage body 121 through the holes formed in the periphery of the valve core body 111, the rotary cage body 121 is used for second-step atomization of the liquid pesticide, and the liquid pesticide after the second-step atomization is sprayed to plants from the holes formed in the periphery of the rotary cage body 121, such that the obtained droplet is more uniform in particle size, and the pesticide application effect can be improved.

In an alternative embodiment, as shown in FIG. 2 and FIG. 3, the projection area of the bottom wall on the first connecting portion 122 is less than the area of the first connecting portion 122.

As the atomizing effect of the rotary cage atomizer 100 is affected by airflows generated by the paddle 150, the resistance that the droplets leave the rotary cage atomizer 100 is reduced in a way of forming a winglet by the first connecting portion 122, so as to improve the atomizing effect.

A convex height h of the winglet is related to a flight speed v of an aircraft for which the rotary cage atomizer 100 is suitable. The greater the flight speed v, the greater the convex height h of the winglet. The less the flight speed v, the less the convex height h of the winglet.

Illustratively, the area of the first connecting portion 122 is a, the projection area on the first connection portion 122 is b, and an area difference between the area of the first connecting portion 122 and the projection area on the first connection portion 122 is c. The greater the flight speed v of the aircraft, the greater the c. The less the flight speed v of the aircraft, the less the c.

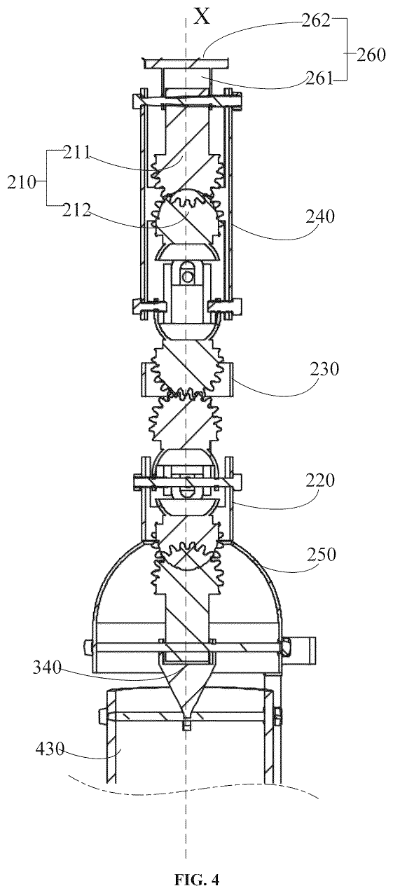

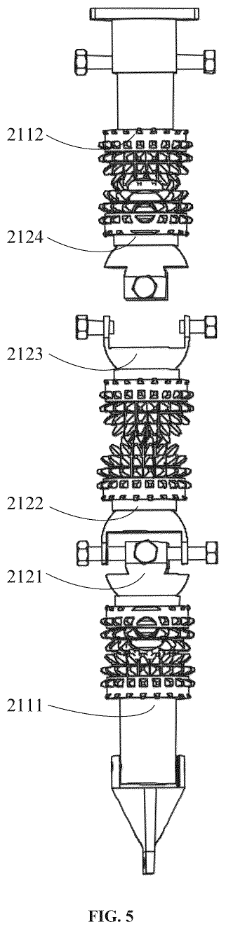

In an alternative embodiment, as shown in FIG. 4 and FIG. 5, the deflection mechanical arm 200 includes multiple pairs of spherical gear assemblies 210 arranged in sequence.

During actual use, a user can adjust the number of the pairs of the spherical gear assemblies 210 according to actual conditions.

It may be understood that the deflection mechanical arm 200 may be formed by an involute spherical gear, which has high transmission precision and wide application range, and can achieve the transmission between any two axes in spaces such as parallel axis, intersecting axis and staggered axis, while the spherical gear can achieve the deflection in any direction in the space. If the multiple pairs of spherical gears are engaged, a large and controllable deflection angle can be achieved, and a gear transmission pair composed of the spherical gears can achieve multi-directional angle adjustment of the deflection mechanical arm 200, thus achieving the angle adjustment of the rotary cage atomizer 100.

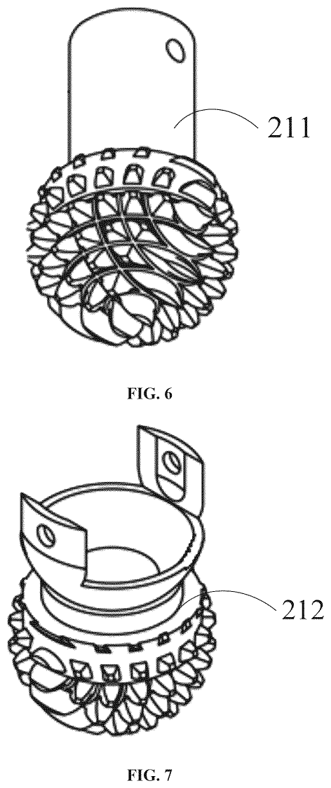

In an alternative embodiment, as shown in FIG. 4, FIG. 5, FIG. 6 and FIG. 7, in a case that the deflection mechanical arm 200 includes three pairs of spherical gear assemblies 210, the deflection mechanical arm 200 further includes a primary holder 220, a secondary holder 230, a tertiary holder 240, and a bottom hood 250.

The primary holder 220 is connected to the bottom hood 250, the bottom bood 250 is connected to a convex spherical gear 211 in a first pair of spherical gear assembly 210, and the primary holder 220 is connected to a concave spherical gear 212 in a second pair of spherical gear assembly 210. The secondary holder 230 is connected to a concave spherical gear 212 in the first pair of spherical gear assembly 210 and a concave spherical gear 212 in a third pair of spherical gear assembly 210. The tertiary holder 240 is connected to a convex spherical gear 211 in the third pair of spherical gear assembly 210 and the concave spherical gear 212 in the second pair of spherical gear assembly 210.

Specifically, one end, away from the driving assembly 400, of the bottom hood 250 is connected to the primary holder 220, and one end, close to the driving assembly 400, of the bottom hood 250 is connected to a first convex spherical gear 2111. The other end of the primary holder 220 is connected to a second concave spherical gear 2122. The secondary holder 230 is connected to a first concave spherical gear 2121 and a fourth concave spherical gear 2124. The tertiary holder 240 is connected to a second convex spherical gear 2112 and a third concave spherical gear 2123.

The first convex spherical gear 2111, the first concave spherical gear 2121, the second concave spherical gear 2122, the third concave spherical gear 2123, the fourth concave spherical gear 2124 and the second convex spherical gear 2112 are arranged in sequence. The first convex spherical gear 2111 abuts against the first concave spherical gear 2121, which is the first pair of spherical gear assembly 210. The second concave spherical gear 2122 abuts against the third concave spherical gear 2123, which is the second pair of spherical gear assembly 210. The fourth concave spherical gear 2124 abuts against the second convex spherical gear 2122, which is the third pair of spherical gear assembly 210.

It needs to be noted that each pair of spherical gear assembly 210 is opposite in rotating directions.

Illustratively, when the first convex spherical gear 2111 deffects rightwards, the first concave spherical gear 2121 deflects leftwards. When the second concave spherical gear 2122 deflects rightwards, the third concave spherical gear 2123 deflects leftwards. When the fourth concave spherical gear 2124 deflects rightwards, the second convex spherical gear 2112 deflects leftwards.

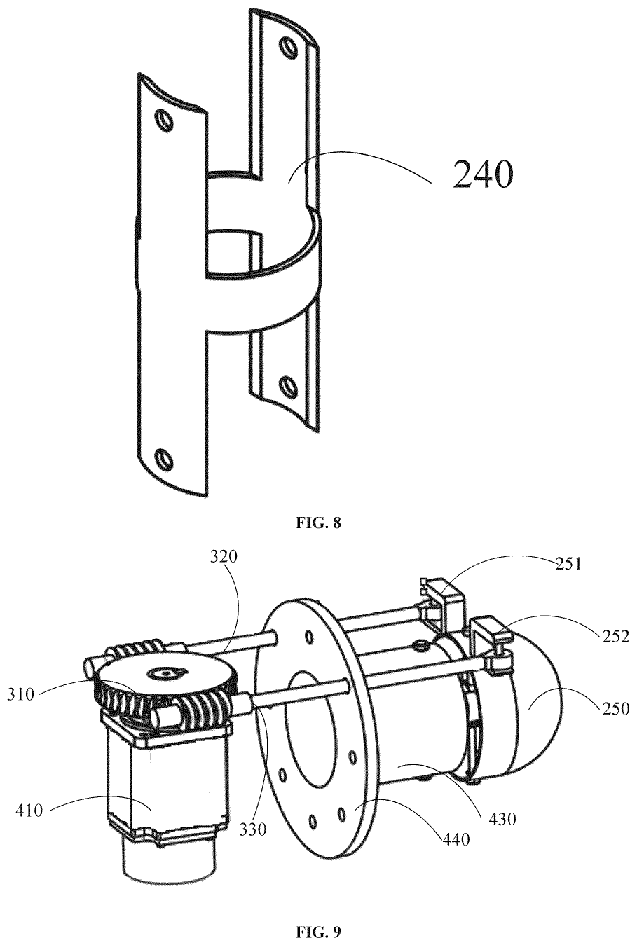

As shown in FIG. 8, two spherical gears are connected to each of the secondary holder 230 and the tertiary holder 240, thus the secondary holder 230 and the tertiary holder 240 may be consistent in shape and size. For example, each of the secondary holder 230 and the tertiary holder 240 may be “H”-shaped. Due to the fact that only one spherical gear is connected to the primary holder 220, the primary holder 220 may be “concave”.

Further, in a case that the deflection mechanical arm 200 includes three pairs of spherical gear assemblies, the primary holder 220 sleeves upper and lower sides of the second concave spherical gear 2122. The secondary holder 230 sleeves left and right sides of the first concave spherical gear 2121 and the fourth concave spherical gear 2124. The tertiary holder 240 sleeves upper and lower sides of the second convex spherical gear 2112 and the third concave spherical gear 2123.

That is, mounting directions of the adjacent holders are staggered with each other. According to such an arrangement, when three pairs of spherical gear assemblies 210 rotate, the primary holder 220, the secondary holder 230 and the tertiary holder 240 are free of interfering with each other, and the flexibility of angular rotation of the deflection mechanical arm 200 can be improved.

A deflection direction of the secondary holder 230 is the same as that of the first concave spherical gear 2121, a deflection direction of the fourth concave spherical gear 2124 is opposite to that of the first concave spherical gear 2121. When the first concave spherical gear 2121 deflects rightwards, the primary holder 220 deflects rightwards, and the fourth concave spherical gear 2124 deflects leftwards. A deflection direction of the tertiary holder 240 is the same as that of the second convex spherical gear 2112, a deflection direction of the third concave spherical gear 2123 is opposite to that of the second convex spherical gear 2112. When the second convex spherical gear 2112 deflects rightwards, the tertiary holder 240 deflects rightwards, and the third concave spherical gear 2123 deflects leftwards.

Illustratively, when the bottom hood 250 deflects rightwards, the first convex spherical gear 2111 connected to the bottom hood 250 deflects rightwards accordingly. As the first convex spherical gear 2111 is connected to the first concave spherical gear 2121, the first concave spherical gear 2121 deflects leftwards. As the first concave spherical gear 2121 is connected to the secondary holder 230, the secondary holder 230 deflects leftwards accordingly. Moreover, as the fourth concave spherical gear 2124 is also connected to the secondary holder 230, the fourth concave spherical gear 2124 deflects rightwards.

Since the fourth concave spherical gear 2124 abuts against the second convex spherical gear 2112, when the fourth concave spherical gear 2124 deflects rightwards, the second convex spherical gear 2112 deflects leftwards. When the second convex spherical gear 2112 is connected to the tertiary holder 240, the tertiary holder 240 deflects leftwards. The third concave spherical gear 2123 is connected to the tertiary holder 240, and thus the third concave spherical gear 2123 deflects rightwards.

As the second concave spherical gear 2122 abuts against the third concave spherical gear 2123, the second concave spherical gear 2122 deflects leftwards. Due to the fact that the first adapter 140 is connected to the second convex spherical gear 2112 of the deflection mechanical arm 200 via the second adapter 260, when the second convex spherical gear 2112 deflects leftwards. the first adapter 140 deflects leftwards, and then the rotary cage atomizer 100 deflect leftwards.

When the bottom hood 250 deflects leftwards, the first convex spherical gear 2111 connected to the bottom hood 250 deflects leftwards accordingly. As the first convex spherical gear 2111 is connected to the first concave spherical gear 2121, the first concave spherical gear 2121 deflects rightwards. As the first concave spherical gear 2121 is connected to the secondary holder 230, the secondary holder 230 deflects rightwards accordingly. Moreover, as the fourth concave spherical gear 2124 is also connected to the secondary holder 230, the fourth concave spherical gear 2124 deflects leftwards.

Since the fourth concave spherical gear 2124 abuts against the second convex spherical gear 2112, when the fourth concave spherical gear 2124 deflects leftwards, the second convex spherical gear 2112 deflects rightwards. When the second convex spherical gear 2112 is connected to the tertiary holder 240, the tertiary holder 240 deflects rightwards. The third concave spherical gear 2123 is connected to the tertiary holder 240, and thus the third concave spherical gear 2123 deflects leftwards.

As the second concave spherical gear 2122 abuts against the third concave spherical gear 2123, the second concave spherical gear 2122 deflects rightwards. Due to the fact that the first adapter 140 is connected to the second convex spherical gear 2112 of the deflection mechanical arm 200 via the second adapter 260, when the second convex spherical gear 2112 deflects rightwards, the first adapter 140 also deflects rightwards, and then the rotary cage atomizer 100 deflect rightwards.

In brief, the deflection direction of the rotary cage atomizer 100 is opposite to that of the first convex spherical gear 2111, and is the same as that of the second convex spherical gear 2112.

In an alternative embodiment, as shown in FIG. 1 and FIG. 3, the first adapter 140 includes a cover body 142, a first vertical portion 143 extending to a circumferential side of the cover body 142, an inclined portion 144 bent from the first vertical portion 143, and a second vertical portion 145 extending from the inclined portion 144. The side wall is covered with the cover body 142, the cover body 142 is provided with the liquid inlet 141, and the second vertical portion 145 is connected to the convex spherical gear 211 in the third pair of spherical gear assembly 210.

Specifically, the side wall of the blade mounting base 151 is covered with the cover body 142, the second vertical portion 145 is connected to the second convex spherical gear 2112 in the third pair of spherical gear assembly 210. Therefore, the deflection direction of the second vertical portion 145 is the same as that of the second convex spherical gear 2112. For example, when the second convex spherical gear 2112 deflects rightwards, the second vertical portion 145 also deflects rightwards, thus driving the rotary cage atomizer 100 to deflect rightwards.

In addition, as the side wall of the blade mounting base 151 of the paddle 150 is generally circular, to facilitate the mounting, correspondingly, the cover body 142 of the first adapter 140 should be circular, and a diameter of the cover body 142 should be greater than that of the side wall of the blade mounting base 151, and the cover body 142 may partially overlap with the side wall of the blade mounting base 151.

It may be understood that the rotary cage atomizer 100 is connected to the deflection mechanical arm 200 via the first adapter 140, thus making the rotary cage atomizer 100 and the deflection mechanical arm 200 located on planes with different heights.

In an alternative embodiment, as shown in FIG. 3 and FIG. 4, the deflection mechanical arm 200 further includes a second adapter 260. The second adapter 260 includes a first sleeve 261, and a first bottom plate 262 arranged on one side of the first sleeve 261. The first sleeve 261 sleeves the convex spherical gear 211 in the third pair of spherical gear assembly 210, and the second vertical portion 145 is connected to the first bottom plate 262.

Specifically, the first sleeve 261 sleeves the second convex spherical gear 2112 in the third pair of spherical gear assembly 210, and the second vertical portion 145 is connected to the second convex spherical gear 2112 via the first bottom plate 262. The deflection of the second convex spherical gear 2112 may drive the second adapter 260 to deflect, while the second adapter 260 drives the second vertical portion 145 to deflect. The deflection direction of the second adapter 260 is the same as that of the second convex spherical gear 2112. For example, when the second convex spherical gear 2112 deflects rightwards, the second adapter 260 also deflects rightwards.

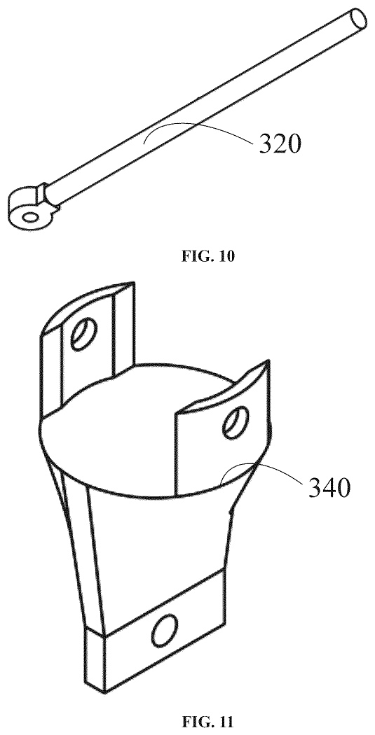

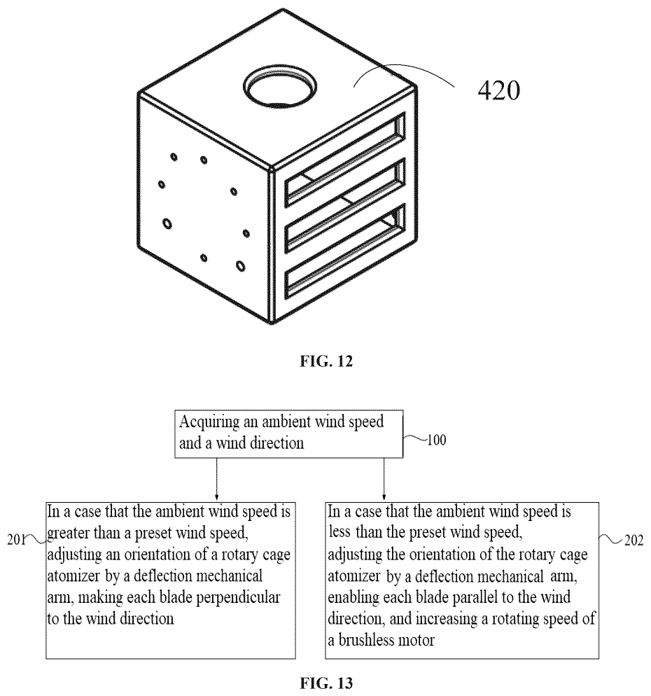

In an alternative embodiment, as shown in FIG. 1, FIG. 9, FIG. 10, FIG. 11 and FIG. 12, the driving assembly 400 includes a driving motor 410, and a driving motor mounting base 420. The transmission assembly 300 includes a worm wheel 310, a first worm 320, a second worm 330, and a third adapter 340.

The driving motor 410 is arranged on the driving motor mounting base 420, the worm wheel 310 is arranged on an output shaft of the driving motor 410, and the first worm 320 and the second worm 330 are meshed with the worm wheel 310. The first worm 320 penetrates through the driving motor mounting base 420 and is movably connected to a periphery of the bottom hood 250. The second worm 330 penetrates through the driving motor mounting base 420 and is movably connected to the periphery of the bottom hood 250. The first worm 320 and the second worm 330 are arranged in parallel. One end of the third adapter 340 is movably connected to the convex spherical gear 211 in the first pair of spherical gear assembly 210, and the other end of the third adapter 340 is movably connected to the driving motor mounting base 420.

The number of heads Z1 of each of the first worm 320 and the second worm 330 is equal to 1, the modulus m is equal to 5, a pressure angle a is equal to 20°, a diameter d1 of an indexing circle is equal to 22.4 mm, and the number of teeth Z2 of each of the first worm 320 and the second worm 330 is equal to 41.

Specifically, the driving motor 410 is arranged inside the driving motor mounting base 420, the driving motor mounting base 420 is provided with through holes for connecting the first worm 320 and the second worm 330 with the bottom hood 250. The first worm 320 and the second worm 330 may move in the through holes. The periphery of the bottom hood 250 is provided with a first movable connector 251 and a second movable connector 252. The first movable connector 251 is movably connected to the first worm 320, and the second movable connector 252 is movably connected to the second worm 330.

As shown in FIG. 4, one end of the third adapter 340 is movably connected to the first convex spherical gear 2111 in the first pair of spherical gear assembly 210, and the first convex spherical gear 2111 is also connected to the bottom hood 250. That is, the first convex spherical gear 2111 is arranged in the third adapter 340, and the third adapter 340 is arranged in the bottom hood 250. Therefore, when the bottom hood 250 deflects, the third adapter 340 also deflects, thus driving the first convex spherical gear 2111 to deflect.

Illustratively, with an axis X as the reference, when the driving motor 410 rotates forwards, the worm wheel 310 rotates clockwise, the first worm 320 moves forward relative to a direction of the first movable connector 251, and the second worm 330 retreats relative to a direction of the second movable connector 252. Therefore, the bottom hood 250 deflects rightwards to drive the third adapter 340 to deflect rightwards, and the first convex spherical gear 2111 also deflects rightwards. Because the deflection direction of the rotary cage atomizer 100 is opposite to that of the first convex spherical gear 2111, the rotary cage atomizer deflects leftwards. When the driving motor 410 rotates reversely, the worm wheel 310 rotates counterclockwise, the first worm 320 retreats relative to the direction of the first movable connector 251, and the second worm 330 moves forward relative to the direction of the second movable connector 252. Therefore, the bottom hood 250 deflects leftwards to drive the third adapter 340 to deflect leftwards, the first convex spherical gear 2111 also deflects leftwards, and the rotary cage atomizer 100 deflects rightwards.

In an alternative embodiment, as shown in FIG. 3 and FIG. 9, the driving assembly 400 further includes a second sleeve 430, and a second bottom plate 440. The second sleeve 430 is arranged on a periphery of the driving motor mounting base 420 via the second bottom plate 440, each of the first worm 320 and the second worm 330 penetrates through the driving motor mounting base 420 and the second bottom plate 440 in sequence, and the other end of the third adapter 340 is movably connected to the second sleeve 430.

Specifically, the second bottom plate 440 is provided with mounting holes corresponding to the driving motor mounting base 420 for the first worm 320 and the second worm 330 to penetrate. In brief, the first worm 320 and the second worm 330 are connected to the outer periphery of the bottom hood 250 after passing through the through holes of the driving motor mounting base 420 and the mounting holes of the second bottom plate 440, respectively. The second bottom plate 440 and the second sleeve 430 are fixed parts, thus avoiding deflection.

The third adapter 340 is connected to the driving motor mounting base 420 via the second sleeve 430, and the third adapter 340 is movably connected to the second sleeve 430. For example, one end, connected to the second sleeve 430, of the third adapter 340 is provided with a bolt hole, a bolt is used to connect the second sleeve 430 and the third adapter 340 through the bolt hole, and the third adapter 340 can deflect leftwards or rightwards through the bolt hole.

As the bottom hood 250 and the second sleeve 430 are connected to the third adapter 340, the bottom hood 250 deflects in the operating process of the atomizer for aerial spraying. To guarantee an enough deflection space for the bottom hood 250, the second sleeve 430 and the bottom hood 250 should kept at a certain distance.

In addition, as shown in FIG. 13, a control method of an atomizer for aerial spraying is further provided, including the following steps.
Step 100. Ambient wind speed and wind direction are acquired.
Step 201. In a case that the ambient wind speed is greater than preset wind speed, an orientation of a rotary cage atomizer 100 is adjusted by a deflection mechanical arm 200, making each blade 152 perpendicular to the wind direction.
Step 202. In a case that the ambient wind speed is less than preset wind speed, the orientation of the rotary cage atomizer 100 is adjusted by the deflection mechanical arm 200, making each blade 152 parallel to the wind direction, and increasing the rotation speed of a brushless motor 130.

As shown in FIG. 2, the atomizer for aerial spraying is further provided with a sensor assembly 500, including a rotation speed sensor 510, a flow sensor 520, and a wind speed and wind direction sensor 530. In order to facilitate the monitoring by the sensor assembly 500, the sensor assembly 500 is arranged on the rotary cage atomizer 100. The rotation speed sensor 510 is used to monitor an actual rotation speed of the rotary cage atomizer 100, and is arranged in the brushless motor 130. A Hall sensor may be adopted as the rotation speed sensor 510. The flow sensor 520 is used to monitoring liquid pesticide flow Q in the rotary cage atomizer 100, and a Hall flow sensor 520 can be used. The wind speed and wind direction sensor 530 is used to monitor the ambient wind speed and wind direction.

In addition, the atomizer for aerial spraying is provided with a control main board, which is used to receive data monitored by the sensor assembly 500 and to feed back the data to the driving assembly 400. The control main board may employ single chip microcomputer stm32f103 series. The sensor assembly 500 is used to transmit the detected data to the control main board through a serial communication mode.

At the beginning of pesticide application, the control main board controls the rotary cage atomizer 100 to reset. When the sensor assembly 500 acquires an actual rotation speed V2 of the rotary cage atomizer 100, an ambient wind speed V1 and a wind direction F, an instruction is sent out by the control main board to adjust a drift angle A of the rotary cage atomizer 100 and keep the wind direction F perpendicular to the blade 152 of the rotary cage atomizer 100. When the ambient wind speed V1 acquired by the sensor assembly 500 is less than 1 m/s, each blade 152 is enabled to be parallel to the wind direction, and the rotation speed of the brushless motor is increased, so as to reduce the stay time of droplets in the air and the phenomenon of droplet drift.

When an altitude sensor detects the altitude change, the control main board calculates a direction of the rotary cage atomizer 100 and the rotation speed of the rotary cage atomizer 100 based on the current flight altitude. That is, the actual rotation speed and drift angle of the rotary cage atomizer 100 are in a dynamic change state, the movement time of the droplet in the air is reduced, and the droplet drift is reduced.

When the aircraft suspends the spraying operation, the paddle of the rotary cage atomizer 100 may generate wind resistance and drive the rotary cage atomizer 100 to idle. An instruction of suspending the operation is sent out by the control main board, the rotary cage atomizer 100 steers, making a direction the rotary cage atomizer 100 perpendicular to a flight direction, so as to reduce the wind resistance of the paddle. Therefore, the strain of key mechanical components of the rotary cage atomizer 100 caused by idling of the rotary cage atomizer 100 can be reduced.

In the embodiments of the present disclosure, in the process of pesticide application by flying, the sensor assembly 500 measures the ambient wind speed V1, the wind direction F, the actual rotation speed V2 of the rotary cage atomizer 100, and pesticide application flow Q, and transmits the data to the control main board. The control main board receives, processes and feeds back the collected data to obtain a required set rotation speed V3 of the rotary cage atomizer 100 and a deflection angle A of the deflection mechanical arm 200, and compares the actual rotation speed V2 of the rotary cage atomizer 100 with the set rotation speed V3, the deflection angle A of the deflection mechanical arm 200 with the ambient wind speed V1 and the wind direction F in real time, and then sends out a control signal. After receiving the control signal, the driving assembly 400 is automatically adjusted to a corresponding operation state to finally achieve the automatic adjustment of the angle and rotation speed of the rotary cage atomizer 100, thereby reducing the movement time of the droplets in the air and reducing the droplet drift.

Finally, it should be noted that the above embodiments are only used to illustrate the technical solution of the present disclosure rather than limiting. Although the present disclosure has been described in detail with reference to the foregoing embodiments, those of ordinary skill in the art should understand that it is still possible to modify the technical solution described in the foregoing embodiments, or to replace some technical features with equivalents. However, these modifications or substitutions do not make the essence of the corresponding technical solutions deviate from the spirit and scope of the technical solutions of various embodiments of the present disclosure.

1. An atomizer for aerial spraying, comprising a rotary cage atomizer, a deflection mechanical arm, a transmission assembly, and a driving assembly;
wherein the rotary cage atomizer comprises a primary atomizing valve core, a secondary atomizing rotary cage, a brushless motor, a first adapter, and a paddle; the primary atomizing valve core is arranged in the secondary atomizing rotary cage, the paddle comprises a blade mounting base and a plurality of blades; the blade mounting base comprises a liquid pipeline, a side wall arranged on a periphery of the liquid pipeline, and a bottom wall for connecting the liquid pipeline and the side wall; the side wall is movably covered with the first adapter, and the first adapter is opposite to the bottom wall; the first adapter is provided with a liquid inlet in communication with the liquid pipeline, the brushless motor sleeves the liquid pipeline, and the plurality of blades are arranged on a periphery of the side wall in a circumferential direction of the side wall; the secondary atomizing rotary cage is connected to the bottom wall, the first adapter is connected to the deflection mechanical arm, and the deflection mechanical arm is connected to the driving assembly via the transmission assembly.

2. The atomizer for aerial spraying according to claim 1, wherein the secondary atomizing rotary cage comprises a rotary cage body and a first connecting portion, an opening of the rotary cage body is covered with the first connecting portion, and the first connecting portion is provided with a first via hole;
the primary atomizing valve core comprises a valve core body and a second connecting portion; an opening of the valve core body is covered with the second connecting portion, and the second connecting portion is provided with a second via hole; the first connecting portion is provided with a first side and a second side opposite to each other, the second connecting portion is arranged on the first side, the bottom wall is arranged on the second side, and the first via hole, the second via hole, the liquid pipeline and the liquid inlet are in communication with one another in sequence.

3. The atomizer for aerial spraying according to claim 2, wherein a projection area of the bottom wall on the first connecting portion is less than an area of the first connecting portion.

4. The atomizer for aerial spraying according to claim 1, wherein the deflection mechanical arm comprises a plurality of pairs of spherical gear assemblies arranged in sequence.

5. The atomizer for aerial spraying according to claim 4, wherein in a case that the deflection mechanical arm comprises three pairs of spherical gear assemblies, the deflection mechanical arm further comprises a primary holder, a secondary holder, a tertiary holder, and a bottom hood;
the primary holder is connected to the bottom hood, the bottom hood is connected to a convex spherical gear in a first pair of spherical gear assembly, the primary holder is connected to a concave spherical gear in a second pair of spherical gear assembly, the secondary holder is connected to a concave spherical gear in the first pair of spherical gear assembly and a concave spherical gear in a third pair of spherical gear assembly, and the tertiary holder is connected to a convex spherical gear in the third pair of spherical gear assembly and the concave spherical gear in the second pair of spherical gear assembly.

6. The atomizer for aerial spraying according to claim 5, wherein the first adapter comprises a cover body, a first vertical portion extending to a circumferential side of the cover body, an inclined portion bent from the first vertical portion, and a second vertical portion extending from the inclined portion; the side wall is movably covered with the cover body, the cover body is provided with the liquid inlet, and the second vertical portion is connected to the convex spherical gear in the third pair of spherical gear assembly.

7. The atomizer for aerial spraying according to claim 6, wherein the deflection mechanical arm further comprises a second adapter, the second adapter comprises a first sleeve, and a first bottom plate arranged on one side of the first sleeve, the first sleeve sleeves the convex spherical gear in the third pair of spherical gear assembly, and the second vertical portion is connected to the first bottom plate.

8. The atomizer for aerial spraying according to claim 5, wherein the driving assembly comprises a driving motor, and a driving motor mounting base; the transmission assembly comprises a worm wheel, a first worm, a second worm, and a third adapter;
the driving motor is arranged on the driving motor mounting base, the worm wheel is arranged on an output shaft of the driving motor, the first worm and the second worm are meshed with the worm wheel, the first worm penetrates through the driving motor mounting base and is movably connected to a periphery of the bottom hood; the second worm penetrates through the driving motor mounting base and is movably connected to the periphery of the bottom hood; the first worm and the second worm are arranged in parallel; one end of the third adapter is movably connected to the convex spherical gear in the first pair of spherical gear assembly, and an other end of the third adapter is movably connected to the driving motor mounting base.

9. The atomizer for aerial spraying according to claim 8, wherein the driving assembly further comprises a second sleeve and a second bottom plate; the second sleeve is arranged on a periphery of the driving motor mounting base via the second bottom plate, each of the first worm and the second worm penetrates through the driving motor mounting base and the second bottom plate in sequence, and the other end of the third adapter is movably connected to the second sleeve.

10. A control method of the atomizer for aerial spraying according to claim 1, comprising:
acquiring an ambient wind speed and a wind direction;
in a case that the ambient wind speed is greater than a preset wind speed, adjusting an orientation of the rotary cage atomizer by a deflection mechanical arm, making each blade perpendicular to the wind direction; and
in a case that the ambient wind speed is less than the preset wind speed, adjusting the orientation of the rotary cage atomizer by the deflection mechanical arm, enabling each blade parallel to the wind direction, and increasing a rotation speed of the brushless motor.

11. The control method of the atomizer for aerial spraying according to claim 10, wherein the secondary atomizing rotary cage comprises a rotary cage body and a first connecting portion, an opening of the rotary cage body is covered with the first connecting portion, and the first connecting portion is provided with a first via hole;
the primary atomizing valve core comprises a valve core body and a second connecting portion; an opening of the valve core body is covered with the second connecting portion, and the second connecting portion is provided with a second via hole; the first connecting portion is provided with a first side and a second side opposite to each other, the second connecting portion is arranged on the first side, the bottom wall is arranged on the second side, and the first via hole, the second via hole, the liquid pipeline and the liquid inlet are in communication with one another in sequence

12. The control method of the atomizer for aerial spraying according to claim 11, wherein a projection area of the bottom wall on the first connecting portion is less than an area of the first connecting portion.

13. The control method of the atomizer for aerial spraying according to claim 10, wherein the deflection mechanical arm comprises a plurality of pairs of spherical gear assemblies arranged in sequence.

14. The control method of the atomizer for aerial spraying according to claim 13, wherein in a case that the deflection mechanical arm comprises three pairs of spherical gear assemblies, the deflection mechanical arm further comprises a primary holder, a secondary holder, a tertiary holder, and a bottom hood;
the primary holder is connected to the bottom hood, the bottom hood is connected to a convex spherical gear in a first pair of spherical gear assembly, the primary holder is connected to a concave spherical gear in a second pair of spherical gear assembly, the secondary holder is connected to a concave spherical gear in the first pair of spherical gear assembly and a concave spherical gear in a third pair of spherical gear assembly, and the tertiary holder is connected to a convex spherical gear in the third pair of spherical gear assembly and the concave spherical gear in the second pair of spherical gear assembly.

15. The control method of the atomizer for aerial spraying according to claim 14, wherein the first adapter comprises a cover body, a first vertical portion extending to a circumferential side of the cover body, an inclined portion bent from the first vertical portion, and a second vertical portion extending from the inclined portion; the side wall is movably covered with the cover body, the cover body is provided with the liquid inlet, and the second vertical portion is connected to the convex spherical gear in the third pair of spherical gear assembly.

16. The control method of the atomizer for aerial spraying according to claim 15, wherein the deflection mechanical arm further comprises a second adapter, the second adapter comprises a first sleeve, and a first bottom plate arranged on one side of the first sleeve, the first sleeve sleeves the convex spherical gear in the third pair of spherical gear assembly, and the second vertical portion is connected to the first bottom plate.

17. The control method of the atomizer for aerial spraying according to claim 14, wherein the driving assembly comprises a driving motor, and a driving motor mounting base; the transmission assembly comprises a worm wheel, a first worm, a second worm, and a third adapter;
the driving motor is arranged on the driving motor mounting base, the worm wheel is arranged on an output shaft of the driving motor, the first worm and the second worm are meshed with the worm wheel, the first worm penetrates through the driving motor mounting base and is movably connected to a periphery of the bottom hood; the second worm penetrates through the driving motor mounting base and is movably connected to the periphery of the bottom hood; the first worm and the second worm are arranged in parallel;
one end of the third adapter is movably connected to the convex spherical gear in the first pair of spherical gear assembly, and an other end of the third adapter is movably connected to the driving motor mounting base.

18. The control method of the atomizer for aerial spraying according to claim 17, wherein the driving assembly further comprises a second sleeve and a second bottom plate; the second sleeve is arranged on a periphery of the driving motor mounting base via the second bottom plate, each of the first worm and the second worm penetrates through the driving motor mounting base and the second bottom plate in sequence, and the other end of the third adapter is movably connected to the second sleeve.
